(19) United States
(12) Patent Application Publication
(10) Pub. No.: US 2018/0362794 A1
(43) Pub. Date: Dec. 20, 2018

(54) Semifinished Product, Method of Production and Use Thereof

(71) Applicants: ThyssenKrupp Steel Europe AG, Duisburg (DE); Evonik Degussa GmbH, Essen (DE)

(72) Inventors: Hans Ferkel, Mulheim (DE); Tobias Lewe, Munster (DE); Markus Rudack, Aachen (DE); Bettina Werner, Schwerte (DE); Thorsten Brand, Marl (DE); Thomas Mohr, Haltern am See (DE); Uwe Numrich, Gross-Zimmern (DE); Denis Pukrop, Dulmen (DE)

(21) Appl. No.: 16/108,873

(22) Filed: Aug. 22, 2018

Related U.S. Application Data
(63) Continuation of application No. PCT/EP2016/053810, filed on Feb. 24, 2016.

(51) Int. Cl. C09D 127/12; B32B 15/01; C09D 5/03; B32B 27/30; B32B 15/082

(52) U.S. Cl. CPC C09D 127/12; B32B 15/013; C09D 5/038; B32B 27/304; C09D 7/41; B32B 2327/12; B32B 2311/30; B32B 2311/20; B32B 2311/24; B32B 15/082

(57) ABSTRACT

A semifinished product is disclosed and includes a high-quality, weather-resistant coating. Also disclosed is a method for manufacturing the semifinished product and the use thereof.

### CROSS-REFERENCE TO RELATED APPLICATION

This application is a United States continuation application of International Application No. PCT/EP2016/053810 filed Feb. 24, 2016, the disclosure of which is hereby incorporated in its entirety by reference.

### BACKGROUND OF THE INVENTION

### Field of the Invention

The present invention relates to a semifinished product with a high-performance and weathering-resistant coating and with very good protection from corrosion to combine long life in relation to aesthetic considerations with the traditional criteria of powerful protection from corrosion.

### Description of Related Art

When materials are used outdoors, it is impossible to avoid adverse effects caused by weathering. These adverse effects are in particular caused by the UV content of solar radiation, by way of a very wide variety of corrosion mechanisms, via cleaning processes, by windborne materials (sand, dust), or by other corresponding adverse effects in specific applications. Materials that are unprotected or lack adequate surface-finishing thus suffer loss of performance and/or durability. Materials based on a metal substrate are moreover subject to considerable corrosion risk.

The best-known prior art for corrosion-resistant and weathering-resistant coil coating surface finishing and surface decoration uses what are known as PVDF coatings, but these have significant design disadvantages because the achievable gloss is exclusively in the medium-gloss range (from 25 to 35 gloss units, measured in the Gardner test at 60°). Coatings of that type moreover have comparatively low surface hardness.

### SUMMARY OF THE INVENTION

The object of the present invention consists in the provision of improved semifinished products which ideally can provide sustainable protection from corrosion, can be used as colorant coatings or colorant decoration, allow construction of appropriately designed surfaces (high gloss, medium gloss, matt), and can provide sustainable surface finishing.

In demanding indoor and, in particular, outdoor applications, these semifinished products with high-quality surfaces are therefore intended to ensure, simultaneously, particularly good surface hardness (abrasion resistance, scratch resistance), weathering resistance and substrate-protection properties, and also excellent protection from corrosion.

The high-quality surfaces are moreover intended to be amenable to easy and cost-efficient production and application.

Other objects not explicitly mentioned can be apparent from the description, the claims, or the examples of this application.

In the light of the prior art and of the inadequate technical solution described therein, the present invention provides a successful method for provision of a coating with longlasting improved quality, and thus compliance with the abovementioned complex set of requirements.

In the present invention, a semifinished product is provided that complies with the abovementioned complex set of requirements even when there is, at least in some regions, an increased corrosion risk resulting from mechanical operations or from processing or from damage.

The present invention therefore firstly provides a semifinished product with a metallic core layer or a metallic substrate and with a polymer coating with a formulation comprising from 5 to 70% by weight of hydroxy-functional fluoropolymers, from 5 to 70% by weight of polyesters based on di- or polycarboxylic acids or on derivatives of these and on aliphatic or cycloaliphatic di- or polyols, where at least one aliphatic or cycloaliphatic di- or polycarboxylic acid or derivatives thereof must be present in the polyester, from 2 to 25% by weight of crosslinking agents, from 0.01 to 2% by weight of crosslinking catalysts, up to 20% by weight of UV absorbers and up to 10% by weight of UV stabilizers, characterized in that a metallic anticorrosion layer has been provided to the core layer, and that the metallic anticorrosion layer exhibits cathodic protection from corrosion in respect of the core layer.

In a preferred embodiment, the metallic core layer comprises at least one layer made of steel. The thickness of the core layer is in the range from 0.2 mm to 4 mm, in particular from 0.25 mm to 1.5 mm. Alternatively, the core layer can also be a composite material having a plurality of layers, for example taking the form of a sandwich with external metallic layers and, arranged therebetween, a layer made of a polymer, or else can be a purely metallic composite material.

The structure of the metallic anticorrosion layer is such that it ensures cathodic protection from corrosion in relation to the core layer. For this purpose, the anticorrosion layer comprises elements which are less mobile than the core layer, i.e. have a lower potential in the electrochemical series.

In preferred embodiments, the anticorrosion layer comprises zinc (Zn), tin (Sn), aluminum (Al), magnesium (Mg) or alloys of these. Examples of relevant alloys are zinc-aluminum, examples being compositions known as Galfan (about 95% of Zn and 5% of Al) and galvalume (about 55% of Al, 43-45% of Zn and 1-2% of Si), and zinc-magnesium.

The thickness of the anticorrosion layer is in the range from 1 μm to 200 μm, preferably in the range from 5 μm to 100 μm, particularly preferably in the range from 10 μm to 50 μm.

In a preferred embodiment of the present invention, the fluoropolymers and the polyesters preferably make up in total from 20% to 75% by weight of the formulation.

The weight data for the individual constituents of the formulations of the invention can be varied freely within the scope of the abovementioned boundaries, with the condition that the total is 100% by weight.

The coatings produced by means of the formulations of the invention feature a sustainable barrier to corrosive materials, high resistance to effects of weathering and of erosion, adequate resilience in the event of buckling and bending, and chemical resistance to cleaning compositions and to graffiti removers. The coatings based on the formulations of the invention moreover have dirt-repellant properties, an advantageous cost-benefit ratio, and sufficient opacity or covering power in the case of a colorant coating with low coating thicknesses, i.e. they exhibit very good pigment dispersity. With these coatings, it is therefore possible to achieve a sustainable surface finish, with great versatility of design, for example by virtue of the possibility of producing high-gloss, medium-gloss, or matt surface structures.

When coated metal surfaces are used in indoor applications, in particular relating to “white goods” (stoves, refrigerators, washing machines, dishwashers, etc.), the surface finish of the invention provides attractive functionality by virtue of its anticorrosion properties, high lightfastness, and high surface hardness.

The coated semifinished products of the invention therefore have the following advantages over the prior art:

The coatings of the invention are colorfast and have stable gloss, and do not become cloudy on exposure to moisture. The coating moreover exhibits excellent weathering resistance and very good chemicals resistance, for example to all commercially available cleaning compositions. Again, these aspects contribute to surface-quality retention over a long period.

The coatings of the invention here especially have very good properties when the surface is exposed to mechanical loading. The lifetime of the semifinished products is thus prolonged, even in regions with regular sandstorms or with winds containing large quantities of dust, or when the surface is regularly cleaned by brushing.

The coating of the invention is moreover particularly resistant to moisture, in particular to rainwater, humidity or dew. It therefore does not exhibit the known susceptibility to delamination of the coating from the semifinished product on exposure to moisture. The coating of the invention moreover exhibits a particularly good barrier effect in relation to water and oxygen, and therefore has very good properties in relation to sustainable protection from corrosion.

The coatings of the invention moreover have very good surface hardness, and this effect therefore additionally contributes to the long life of semifinished products equipped therewith.

The other particular advantage of the present invention consists in ensuring and maintaining very good protection from corrosion even in the event of damage to the exterior polymer coating or to the entire layer structure during use. By way of example, therefore, despite the drilling of holes during the processing of the semifinished product of the invention, very good protection from corrosion is still provided at the edges of the hole, where there is no covering over the core layer.

The hydroxy-functional fluoropolymers are an essential constituent of the polymer coating. These are specific copolymers based on structural units of a fluorinated polymer, and also on at least one other structural unit differing from the structural unit of a fluorinated polymer. The hydroxy-functional fluoropolymers used in the formulations of the invention are in particular preferably copolymers of tetrafluoroethylene (TFE) and/or chlorotrifluoroethylene (CTFE) on the one hand and of vinyl esters, vinyl ethers and/or alpha-olefins on the other hand, or are corresponding mixtures. The hydroxy-functionality in these polymers is obtained by way of example by copolymerization of hydroxy-functional vinyl ethers and/or alpha-olefins.

Examples of hydroxy-functional fluoropolymers that are suitable in the invention are the commercially obtainable products from Asahi Glass Chemicals with the product name Lumiflon®, from Daikin with the product name Zeffle®, from Central Glass Co. with the product names Cefral Coat® and Cefral Soft®, from Qingdao Hongfen Group Co. with the product name HFS-F-3000 and from Xuzhou Zhongyan Fluoro Chemical Co. with the product name ZY-2.

Another constituent of the polymer coating is provided by the polyesters that are present.

The polyesters present in the polymer coating are based on aliphatic or cycloaliphatic di- or polycarboxylic acids and on aliphatic or cycloaliphatic di- or polyols.

The polyesters used comprise, as starting acid component, at least one aliphatic or cycloaliphatic dicarboxylic acid or polycarboxylic acid or derivatives thereof, e.g. cycloaliphatic 1,2-dicarboxylic acids, e.g. 1,2-cyclohexanedicarboxylic acid or methyltetrahydro-, tetrahydro- or methylhexahydrophthalic acid, succinic acid, sebacic acid, undecanedioic acid, dodecanedioic acid, adipic acid, azelaic acid, pyromellitic acid, trimellitic acid, isononanoic acid and/or dimer fatty acid.

The polyester used can moreover optionally comprise, alongside the aliphatic or cycloaliphatic dicarboxylic acids or polycarboxylic acids or derivatives thereof, other carboxylic acids, for example aromatic dicarboxylic acids or polycarboxylic acids. Examples of suitable aromatic acids are phthalic acid, isophthalic acid and terephthalic acid. The proportion of the aliphatic or cycloaliphatic dicarboxylic acids or polycarboxylic acids in the acid content of the polyesters used in the invention is at least 35 mol %, based on the entirety of all of the di- or polycarboxylic acids, preferably at least 45 mol %, and in a very particularly preferred embodiment 100 mol %, i.e. it is very particularly preferable that the polyester is based exclusively on aliphatic or cycloaliphatic dicarboxylic acids or polycarboxylic acids.

For the purposes of the present application, the expression derivatives of the dicarboxylic acid or polycarboxylic acid preferably means the respective anhydrides or esters, in particular methyl esters or ethyl esters.

The di- or polyols are aliphatic or cycloaliphatic diols or polyols, for example monoethylene glycol, diethylene glycol, dipropylene glycol, triethylene glycol, tetraethylene glycol, 1,3-propanediol, 1,2-propanediol, 1,4-butanediol, 1,5-pentanediol, 1,6-hexanediol, 1,9-nonanediol, 1,12-dodecanediol, 1,3-butylethylpropanediol, 2-methyl-1,3-propanediol, cyclohexanedimethanol or neopentyl glycol. They can also be oligomeric diols such as oligoethylene glycol, oligopropylene glycol and other oligoethers.

It is also possible to use polyols having more than two functional groups, for example trimethylolethane, trimethylolpropane, pentaerythritol or glycerol. It is moreover possible to use lactones and hydroxycarboxylic acids as di- or polyols.

Preference is given by way of example to 1,3-methylpropanediol, 2,2′-dimethylpropane-1,3-diol, neopentyl glycol, ethylene glycol, 1,6-hexanediol and/or trimethylolpropane as aliphatic or cycloaliphatic di- or polyols.

The acid number, determined in accordance with DIN EN ISO 2114, of the polyesters used in the polymer coating is preferably from 0 to 10 mg KOH/g, preferably from 0 to 5 mg KOH/g, in particular from 0 to 3 mg KOH/g. The acid number (AN) is the quantity of potassium hydroxide in mg required to neutralize the acids present in one gram of material. The sample to be studied is dissolved in dichloromethane and titrated with 0.1 N ethanolic potassium hydroxide solution, with phenolphthalein as indicator.

The OH number of the polyesters used in the polymer coating is from 15 to 150 mg KOH/g, preferably from 20 to 100 mg KOH/g. For the purposes of the present application, the OH numbers are determined in accordance with DIN 53240-2. In this method, the sample is reacted with acetic anhydride in the presence of 4-dimethylaminopyridine as catalyst, whereupon the hydroxy groups are acetylated. One molecule of acetic acid is produced here for each hydroxy group, while the subsequent hydrolysis of the excess acetic anhydride provides two molecules of acetic acid. The consumption of acetic acid is determined titrimetrically from the difference between experimental value and a zero value obtained in parallel.

The resultant number-average molar masses Mn are from 1000 to 10 000 g/mol, preferably from 2000 to 7000 g/mol.

For the purposes of the present invention, the molar mass is determined by means of gel permeation chromatography (GPC). The samples are characterized in tetrahydrofuran as eluent in accordance with DIN 55672-1.

Mn (UV)=number-average molar mass (GPC, UV detection), stated in g/mol
Mw (UV)=mass-average molar mass (GPC, UV detection), stated in g/mol

The polyesters used are produced by known processes (see Dr. P. Oldring, Resins for Surface Coatings, Volume III, published by Sita Technology, 203 Gardiness House, Bromhill Road, London SW18 4JQ, England 1987) by (semi)continuous or batchwise esterification of the starting acids and starting alcohols in a single-stage or multistage procedure.

The polyesters are preferably synthesized by way of a melt condensation procedure. For this, the abovementioned di- or polycarboxylic acids and di- or polyols are used as initial charge in a ratio of equivalents of hydroxy groups to equivalents of carboxy groups of from 0.5 to 1.5, preferably from 1.0 to 1.3, and melted. The polycondensation takes place in the melt at temperatures of from 150 to 280° C. within a period of from 3 to 30 h, preferably in an inert gas atmosphere. Nitrogen or noble gases, in particular nitrogen, can be used as inert gas. The oxygen content of the inert gas is less than 50 ppm, in particular less than 20 ppm. Much of the quantity of the water liberated here is first removed by distillation at atmospheric pressure. The remaining water of reaction, and also volatile diols, are then removed until the desired molar mass has been achieved. This can optionally be facilitated via reduced pressure, surface enlargement, or passage of a stream of inert gas. The reaction can be additionally accelerated by adding an entrainer and/or a catalyst before or during the reaction. Examples of suitable entrainers are toluene and xylenes. Typical catalysts are organotitanium compounds or organotin compounds, for example tetrabutyl titanate or dibutyltin oxide. It is also possible to use catalysts based on other metals, e.g. zinc or antimony, or else metal-free esterification catalysts. It is moreover possible to use other additives and operating auxiliaries such as antioxidants or color stabilizers.

Examples of suitable hydroxy-functional copolyesters are the products commercially obtainable from Evonik Industries AG, DYNAPOL®, LH 748-02/B and DYNAPOL®, LH 750-28.

In an embodiment to which preference is further given, the OH number of the fluoropolymers and the polyesters together is from 20 to 350 mg KOH/g, preferably from 30 to 250 mg KOH/g.

Another constituent of the polymer coating is provided by crosslinking agents, for example amino resins or polyisocyanates, or else a mixture thereof.

Polyisocyanates here are preferably isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate, 2,4,4-trimethylhexamethylene diisocyanate (TMDI) and/or norbornane diisocyanate (NBDI), inclusive of blocked derivatives thereof.

Examples of a suitable crosslinking agent of this type are Vestanat® EP B 1581 from Evonik Industries AG and Desmodur® BL 3175 from Bayer. The quantity of crosslinking agent is generally adjusted in a manner such that the ratio between the OH groups of the binder mixture, i.e. in particular of the hydroxy-functional fluoropolymer and of the polyester, and of the NCO groups of the polyisocyanate is in the range from 0.5 to 1.5, preferably from 0.8 to 1.2 and particularly preferably from 0.9 to 1.1. The abovementioned ratio ranges apply in particular to the very particularly preferred combination of hexamethylene diisocyanate (HDI) as polyisocyanate and dibutyltin dilaurate (DBTDL) as crosslinking catalyst. In the case of other systems whose components differ more significantly in relation to the respective molar masses or number of functionalities, the stated limiting ranges require appropriate adjustment in a manner known to the person skilled in the art.

Crosslinking catalysts are likewise a constituent of the polymer coating. Crosslinking catalysts normally used are organotin compounds, or else organobismuth compounds, for example dibutyltin dilaurate (DBTDL) or bismuth neodecanoate. Compounds likewise used moreover are tertiary amines, for example 1,4-diazabicyclo[2.2.2]octane, and non-oxidizing organic acids, for example para-toluenesulfonic acid.

Other important parameters for establishing the desired weathering resistance with aesthetic effect, and also substrate-protection properties, of the coating are the following: the formulation of the polymer coating comprises up to 20% by weight, preferably up to 15% by weight, of UV absorbers, preferably of a triazine-based UV absorber, and up to 10% by weight, preferably up to 7.5% by weight, of UV stabilizers, preferably of an HALS-based UV stabilizer.

In a particularly preferred embodiment, the polymer coating comprises from 0.5 to 15% by weight of a triazine-based UV absorber and from 0.3 to 7.5% by weight of an HALS-based UV stabilizer.

The formulations for the polymer coating can be used directly in the form described above: the formulations can be used in the form of powder coatings, i.e. with no solvent. This is of particular interest in the light of the widespread preference for use of powder coatings.

The formulations can moreover also be used in the form of solvent-containing coatings. In this likewise preferred embodiment, the formulations comprise from 5 to 80% by weight of a solvent, preferably up to 50% by weight, based on the formulation.

Solvents that are suitable for the formulations and that can be used are in principle any of the solvents or solvent mixtures that are compatible with the other components used in the invention. These are preferably ketones such as acetone or methyl ethyl ketone, esters such as ethyl, propyl or butyl acetate, aromatics such as toluene or xylene, or ethers such as diethyl ether or ethyl ethoxypropionate, glycol ethers and glycol esters, and also high-boiling-point aromatic fluids such as Solvesso® 150 from ExxonMobil Chemicals.

The polymer coating can moreover additionally comprise up to 40% by weight, based on the formulation, of a hydroxy-functional silicone resin. The OH number of this silicone resin is from 50 to 300 mg KOH/g, preferably from 90 to 200 mg KOH/g. With these silicone resins, the heat resistance of the formulation is additionally increased. When a relatively high proportion of this component is used moreover it is possible to increase the total solids content of the formulation with a somewhat smaller proportion of the other polymer components. XIAMETER®, RSN-0255 from Dow Corning is an example of these hydroxy-functional silicone resins.

The formulation of the polymer coating can moreover additionally comprise up to 20% by weight of a silane-functional alkyl isocyanate or of a glycidyl-functional alkylsilane, based on the formulation. These components generally additionally contribute to adhesion properties and/or to an increase of resistance to scratching and abrasion in relation to the semifinished product that is to be coated. A preferred silane-functional alkyl isocyanate is trimethoxypropylsilyl isocyanate, which is marketed by way of example by Evonik Industries AG as Vestanat® EP-M 95. A preferred example of a glycidyl-functional alkylsilane is 3-glycidyloxypropyltrimethoxysilane, which is obtainable for example from Evonik Industries AG as Dynasylan® GLYMO.

It is moreover in particular also possible that inorganic particles, optionally nanoscale particles, are present in the formulation, mainly for the purposes of pigmentation, and also for additional improvement of resistance to scratching and to abrasion. Possible quantities added of these particles here are up to 40% by weight, preferably up to 30% by weight, based on the formulation. Equally, it is possible by way of example to add appropriate colorants to the formulation for purposes of coloration, for example organic and/or inorganic pigments or dyes.

It is also possible that matting agents are present in the formulation in order to adjust gloss properties. Examples of matting agents that can be used are silicas (e.g. Acematt® from Evonik Resource Efficiency GmbH), silicates, and also fine polyamide powders (e.g. Vestosint* from Evonik Resource Efficiency GmbH) and copolymers.

The thickness of this polymer coating after application to the respective substrate material or semifinished product, and also after subsequent drying and crosslinking, is preferably from 0.5 to 200 μm, preferably from 2 μm to 150 μm and particularly preferably from 5 μm to 50 μm.

In principle, the selection of the metallic core layer or substrate is not subject to any restrictions. Suitable metals are especially any of the types of steel known to the person skilled in the art, and also aluminum and other metals or alloys that are provided with a coating in order to provide protection from corrosion.

The present invention provides not only the coatings described above but also processes for the production of semifinished products.

### DESCRIPTION OF THE INVENTION

In the process of the invention for the coating of a semifinished product, the semifinished product is first provided (A: provision of a metallic core layer), then a metallic anticorrosion layer is provided thereto (B: coating of the core layer with a metallic anticorrosion layer) and the material is then coated with a polymer coating with a formulation described above (C: application of a polymer coating with a formulation as described above), and the coating is then dried and/or calcined (D: subsequent drying and/or calcination of the polymer coating). The formulation constituents crosslink here to the polymer coating.

The metallic anticorrosion layer is preferably applied by means of a hot-dip-coating process, or via an electrolytic or galvanic coating process.

In alternative embodiments, it is also possible to produce the metallic anticorrosion layer by means of other plating processes, for example roll plating, PVD processes or CVD processes.

Application of the metallic anticorrosion layer can optionally be followed by a heat treatment in order to improve the structure of the anticorrosion layer and/or bonding thereof to the core layer, for example via diffusion processes.

Before the application of the polymer coating it is optionally possible to pretreat the surface of the anticorrosion layer.

The process for the coating of semifinished products with the polymer coating has a plurality of embodiments. In the simplest embodiment, the coating takes place directly on to the anticorrosion layer. In a process that is in particular used for this purpose, the formulation in organic solution is applied together with other formulation constituents in the form of “organosol” to the substrate, and the applied layer is then dried. The coating method here is by way of example knife coating, roll coating, dip coating, curtain coating, or spray coating. The crosslinking of the coating takes place in parallel with drying.

In a particularly preferred, but not exclusive, variant of the abovementioned coating variant of the present application, the formulations are used in the context of coil-coating processes. Coil coating is a process for the single- or double-sided coating of surfaces, for example steel coil or aluminum coil. The resultant material is a composite material made of a metallic carrier material comprising a core layer and anticorrosion layer, optionally pretreated, and of an organic polymer coating. Methods for, and embodiments of, coil coating processes are known to the person skilled in the art.

In a second embodiment, the polymer coating is realized in the form of a surface-finishing film, equipped with the coating formulation and applied to the respective substrate material or semifinished product. In this case the coating formulation is first coated onto an appropriate film substrate material, thus adhering securely thereto. This surface-finishing film is applied subsequently to the respective finished substrate material. The underside of the surface-finishing film here has been either coated with a self-adhesive formulation or equipped with a hot melt or with an adhesive layer. A temperature- and pressure-assisted application procedure bonds this modified underside on the finished substrate material.

By way of the properties of the material of the surface-finishing film it is thus possible to realize further product features, including for example optical features. This type of process is moreover very flexible: by way of example, it can be used in situ when semifinished products to be coated are relatively large, without use of solvents or of high temperatures.

In a third variant, similar to the second embodiment, a heat-transfer process is applied to the coating formulation in order to apply the polymer coating to the respective substrate material.

In this case, an appropriate carrier material made of film or of paper is equipped in a first coating step with a release layer which permits heat-transfer, to the respective substrate material, of the coating formulation applied in a second coating step.

It is optionally possible here, if necessary, in a third coating step, to apply an adhesive layer which ensures appropriate adhesion of the heat-transfer layer structure on the respective substrate material.

A fourth embodiment is provided by solvent-free powder coating. Suitable processes and embodiments relating thereto are well known to the person skilled in the art.

One or more further functional layers can then optionally be provided to the polymer coating. These can by way of example be a scratch-resistant coating, a conductive layer, an antisoiling coating and/or a reflection-increasing layer, or other optically functional layers. These additional layers can by way of example be applied by means of Physical Vapor Deposition (PVD) or Chemical Vapor Deposition (CVD).

It is optionally possible to apply an additional scratch-resistant coating for further improvement of scratch resistance. Scratch-resistant coatings can by way of example be silicon oxide layers applied directly by means of PVD or CVD.

The surface of the composite moldings can moreover have what is known as an antisoiling coating, in order to facilitate cleaning. Again, this coating can be applied by means of PVD or CVD.

In another example of an option, there is additionally a further, comparatively thin, extremely abrasion-resistant layer located on the polymer coating. This is a particularly hard thermoset layer, the thickness of which is preferably below 5 μm, particularly preferably from 0.5 to 2.0 μm. This layer can by way of example be produced from a polysilazane formulation. Application sectors for the semifinished products of the invention are found in particular in architecture, allowing creativity in the construction of facades and of roofs and for surface-finishing, and also in the design/construction of other metal structures. This applies in particular in highly stressed outdoor applications, for example sports stadiums, factory/industrial plant structures, bridge construction, transport, marine applications, etc. However, the advantages can also be utilized for indoor applications. Other application sectors for the use of semifinished products of the invention are found in vehicle construction, where this in particular comprises not only private and commercial vehicles but also shipbuilding and aircraft construction, and special-purpose vehicles. Another sector for use of semifinished products of the invention is found in the field of packaging, because the advantages are especially relevant to food packaging. The principle here is to combine “long life in relation to aesthetic considerations” with the traditional criteria of powerful protection from corrosion. In another preferred embodiment, the metal structures are constituents of household equipment (white goods), in particular of stoves, refrigerators, washing machines or dishwashers.

It is assumed that no further information is required to permit a person skilled in the art to make extensive use of the above description. The preferred embodiments and examples are therefore to be interpreted as disclosure that is merely descriptive and certainly not in any way restrictive.

Alternative embodiments of the present invention can be obtained in analogous manner.

### EXAMPLES

Studies relating to the compatibility of polyesters and of fluoropolymers:

| | | Polyester:Lumiflon | | |
|---|---|---|---|---|
| | | LF 200F ratio | | |
| Example | Polyester | 20:80 | 50:50 | 80:20 |
| Example 1 | P1 | extremely | extremely | extremely |
| | | cloudy | cloudy | cloudy |
| Example 2 | P2 | extremely | extremely | extremely |
| | | cloudy | cloudy | cloudy |
| Example 3 | P3 | clear | minimal | clear |
| | | | clouding | |
| Example 4 | P4 | clear | clear | clear |

P1: Dynapol LH 744-23, Evonik Industries AG, polyester based on 45 mol % of aliphatic dicarboxylic acid
P2: Dynapol LH 538-02, Evonik Industries AG, polyester based on 50 mol % of aliphatic dicarboxylic acid, and also on cycloaliphatic dicarboxylic anhydride
P3: Dynapol LH 748-02/B, Evonik Industries AG, polyester based on 100 mol % of cycloaliphatic dicarboxylic anhydride
P4: Dynapol LH 750-28, Evonik Industries AG, polyester based on 100 mol % of cycloaliphatic dicarboxylic anhydride The molar concentrations stated are based in each case on the acid content of the polyester concerned. Lumiflon LF 200, Asahi Glass Chemicals, hydroxy-functional fluoropolymer, based on FEVE (fluorinated ethylene vinyl ether)

| | | Polyester:Lumiflon | | |
|---|---|---|---|---|
| | | LF 916F ratio | | |
| Example | Polyester | 20:80 | 50:50 | 80:20 |
| Example 5 | P1 | extremely | extremely | extremely |
| | | cloudy | cloudy | cloudy |
| Example 6 | P2 | clear | clear | extremely |
| | | | | cloudy |
| Example 7 | P3 | clear | clear | clear |
| Example 8 | P4 | clear | clear | clear |

Lumiflon LF 916F, Asahi Glass Chemicals, hydroxy-functional fluoropolymer, based on fluorinated ethylene vinyl ether (FEVE).

Adequate compatibility with the fluoropolymer-polyol component Lumiflon LF is possessed especially by the polyesters P3 and P4, based solely on aliphatic dicarboxylic acids or appropriate derivatives.

What is claimed is:

1. A semifinished product, the semifinished product comprising a metallic core layer and a polymer coating with a formulation comprising from 5 to 70% by weight of hydroxy-functional fluoropolymers, from 5 to 70% by weight of polyesters based on di- or polycarboxylic acids or on derivatives of these and on aliphatic or cycloaliphatic di- or polyols, where at least one aliphatic or cycloaliphatic di- or polycarboxylic acid or derivatives thereof must be present in the polyester, from 2 to 25% by weight of crosslinking agents, from 0.01 to 2% by weight of crosslinking catalysts, up to 20% by weight of UV absorbers and up to 10% by weight of UV stabilizers, wherein a metallic anticorrosion layer has been provided to the core layer, and wherein the metallic anticorrosion layer exhibits cathodic protection from corrosion in respect of the core layer.

2. The semifinished product as claimed in claim 1, wherein the core layer comprises at least one layer made of steel.

3. The semifinished product as claimed in claim 1, wherein the metallic anticorrosion layer comprises zinc, aluminum, tin, magnesium or alloys of these.

4. The semifinished product as claimed in claim 1, wherein the thickness of the core layer is from 0.2 mm to 4 mm and the thickness of the polymer coating, after drying and crosslinking, is from 0.5 to 200 μm.

5. The semifinished product as claimed in claim 1, wherein the thickness of the metallic anticorrosion layer is from 1 μm to 200 μm.

6. The semifinished product as claimed in claim 1, wherein the polymer coating comprises organic and/or inorganic pigments or dyes.

7. A process for the coating of a semifinished product comprising the steps of:
A. providing a metallic core layer
B. coating the metallic core layer with a metallic anticorrosion layer
C. applying to the coated metallic core layer a polymer coating with a formulation comprising from 5 to 70% by weight of hydroxy-functional fluoropolymers, from 5 to 70% by weight of polyesters based on di- or polycarboxylic acids or on derivatives of these and on aliphatic or cycloaliphatic di- or polyols, wherein at least one aliphatic or cycloaliphatic di- or polycarboxylic acid or derivatives thereof must be present in the polyester, from 2 to 25% by weight of crosslinking agents, from 0.01 to 2% by weight of crosslinking catalysts, up to 20% by weight of UV absorbers and up to 10% by weight of UV stabilizers; and
D. drying and/or calcinating of the polymer coating.

8. The process as claimed in claim 7, wherein, after the application of the anticorrosion layer (step B) and the application of the polymer coating (step C), a heat-treatment is carried out.

9. The process as claimed in claim 7, wherein the resultant coating is provided together with a further scratch-resistant coating, conductive layer, antisoiling coating and/or reflection-increasing layers or other optically functional layers.

10. The use of a semifinished product as claimed in claim 1 in vehicle construction, for packaging, for household equipment or in the construction sector for the construction of facades and of roofs, in the fitting-out of interiors and surface-finishing, and also in the design/construction of other metal structures.

11. The semifinished product as claimed in claim 2, wherein the metallic anticorrosion layer comprises zinc, aluminum, tin, magnesium or alloys of these.

12. The semifinished product as claimed in claim 2, wherein the thickness of the core layer is from 0.2 mm to 4 mm and the thickness of the polymer coating, after drying and crosslinking, is from 0.5 to 200 μm.

13. The semifinished product as claimed in claim 3, wherein the thickness of the core layer is from 0.2 mm to 4 mm and the thickness of the polymer coating, after drying and crosslinking, is from 0.5 to 200 μm.

14. The semifinished product as claimed in claim 2, wherein the thickness of the metallic anticorrosion layer is from 1 μm to 200 μm.

15. The semifinished product as claimed in claim 3, wherein the thickness of the metallic anticorrosion layer is from 1 μm to 200 μm.

16. The semifinished product as claimed in claim 4, wherein the thickness of the metallic anticorrosion layer is from 1 μm to 200 μm.

17. The semifinished product as claimed in claim 2, wherein the polymer coating comprises organic and/or inorganic pigments or dyes.

18. The semifinished product as claimed in claim 3, wherein the polymer coating comprises organic and/or inorganic pigments or dyes.

19. The semifinished product as claimed in claim 4, wherein the polymer coating comprises organic and/or inorganic pigments or dyes.

20. The semifinished product as claimed in claim 5, wherein the polymer coating comprises organic and/or inorganic pigments or dyes.
